(19) United States
(12) Patent Application Publication
(10) Pub. No.: US 2007/0113277 A1
(43) Pub. Date: May 17, 2007

(54) Computer data security method, system and computer utilized thereof

(75) Inventor: Chin-Chun Chiang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/541,685

(22) Filed: Oct. 3, 2006

(30) Foreign Application Priority Data
Nov. 11, 2005 (TW) 94140025

(51) Int. Cl. G06F 12/14

(52) U.S. Cl. 726/18

(57) ABSTRACT

A computer data security method, system and computer thereof, is mainly utilized to check and verify that if the computer is connected to the outside data storage device when the computer is powered-up, and initialize the operation system to activate the computer only after verifying that the power-on password of the computer is compatible with the check-up password in the outside data storage device.

### BACKGROUND

1. Field of Invention

The invention relates a data security method, and in particular to a computer data security method, system and computer thereof utilizing an outside data storage device.

2. Related Art

In recent years, with the increasing popularity and utilization of the computer system, the computer has become a daily necessity for most of the people. In particular, due to the convenience of the computer usage and application, people have become used to storing their confidential data/information into the computer. In order to prevent the illegal access and usage of the stored data, most owners of data stored in the computer utilize a password to determine if the user is allowed to access the data stored in the computer. However, this kind of technology sometimes are still vulnerable to the ill-intended person bent on breaking the security system and obtain the data stored in a computer. Since all the ill-intended person has to do is to break the password, then the data stored in a computer can be copied into a portable data storage device and taken away easily.

To prevent be leaked of the computer data, many locking tools are developed to lock-in the connection port of the computer, so as to prevent the ill-intended person from inserting a data storage device onto a connection port of the computer to steal away the data after breaking the particular password. However, since the password is fixed, thus any ill-intended person may still have a good chance in stealing away the data after breaking the password and the locking device of the computer system.

In addition, in United States Patent Number U.S. Pat. No. 5,852,736 “Data Protection Method & Device Of Computer System Through Utilizing Lock-In Device” is disclosed a technology, which can be utilized to determine if the user is authorized and allowed to access data in a specific storage area of a computer system by verifying that if the lock-in value generated by a specific application program is correct. However, such a system is only capable of providing a specific lock-in value, which is not able to change for the respective data access, thus such a system is not completely safe in reducing the possibility of the lock-in value being broken, and thus the theft of the data. Furthermore, the ill-intended person may even come back for a subsequent break-in action the second time utilizing the data copied and stolen away in the previous successful break-in.

### SUMMARY OF THE INVENTION

In view of the foregoing, the invention provides a computer data security method, system and computer thereof utilizing an outside data storage device, so as to prevent the data stored in a computer from being stolen away.

The computer data security method disclosed by the embodiment of the invention, is utilized to securely activate a computer in cooperation with an outside data storage device The computer is installed an operation system and stored a power-on password, and the outside storage device is stored with a check-up password, comprising the following steps: firstly, receiving the system power-on signal; next, checking to verify if the outside data storage device is electrically connected to the computer. Then, when it is verified that the outside data storage device is connected to the computer, the check-up password is retrieved from the outside storage device. Subsequently, check to verify if the power-on password is compatible with the check-up password. Finally, the operation system is initialized to activate the computer when the power-on password is compatible with the check-up password.

In addition, a computer data security system is disclosed by embodiment of the invention to operate in cooperation with the above-mentioned computer data security method. The computer data security system includes an outside data storage device and a computer. An outside data storage device comprises a check-up password, and may be connected to or separated from the computer. The computer comprises an operation system, a verification module, and a specific storage area used for storing the power-on password. The outside storage device is connected to the computer, which is used to receive the power-on signal and verify that the computer is indeed connected to the outside data storage device. The verification module is used to check whether the check-up password is compatible with the power-on password. When the check-up password is compatible with the power-on password, the operation system is initialized to activate the computer.

Furthermore, a computer is disclosed by the invention, which is connected to an outside data storage device used to store a check-up password. The computer includes an operation system, a verification module, and a specific storage area. Wherein, the specific storage area is used to storage power-on password, the computer is used to receive a power-on signal, and the verification module is used to check whether the check-up password is compatible with the power-on password. When the check-up password is compatible with the power-on password, the operation system is initialized to activate the computer.

Moreover, the embodiment of the invention is provided with an embodiment, which is used to store another power-on password to the computer and the outside storage device to become the new power-on password and new check-up password during the power-down of the computer. When the computer receives the system power-on signal again, such a power-on password can be utilized to power-on the computer. The power-on password could be a long string of characters to effectively prevent the ill-intended person from illegally accessing and obtaining the data stored in the computer.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow as for illustration only, and thus are not limitative of the invention, and wherein:

FIG. 1 is a system flowchart of the various steps of a computer data security method according to an embodiment of the invention; and

FIG. 2 is a system block diagram of a computer data security system according to an embodiment of the invention.

### DETAILED DESCRIPTION OF THE INVENTION

The purpose, construction, features, and functions of the invention can be appreciated and understood more thoroughly through the following detailed description with reference to the attached drawings.

In the embodiment of the invention, the computer data security system is utilized to activate the computer in cooperation with an outside data storage device in a secure manner. The computer is installed an operation system and a power-on password, and the outside data storage device is stored with a check-up password. During the computer power-on, the check-up password stored in the outside data storage device is used to check and verify the validity of the power-on password stored in the computer.

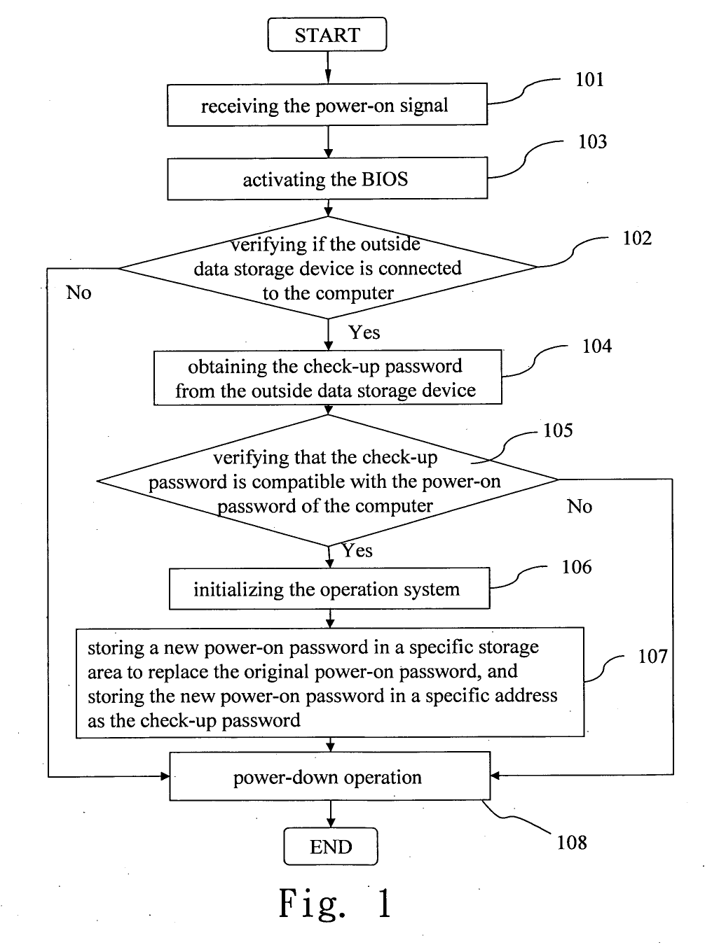

Refer to FIG. 1, which shows a system flowchart of the various steps of a computer data security method according to an embodiment of the invention, wherein, the computer is activated in cooperation with an outside data storage device. Firstly, the system receives a power-on signal (step 101), and activates a basic input/output system (step 102). Then, the outside data storage device is verified to connected to the computer (step 103), and the power-on password stored in the specific storage area of the computer is used to check if it is compatible with the check-up password along with the connection verification. The computer confirms if the check-up password stored in the outside data storage device is correct by the connection of the computer and the outside data storage device. If the outside data storage device is not connected to the computer, the computer system is used to proceed with the power-down process directly (step 108) to safeguard and prevent the access of ill-intended persons.

In case that the outside data storage device is indeed connected to the computer, then the computer is used to get the check-up password from a specific address of the outside data storage device (step 104), and check that if the computer power-on password is compatible with the power-on password (step 105).

However, in case that it is verified that the power-on password stored in the specific storage area of the computer system is not compatible with the check-up password obtained from the outside data storage device, then the computer is power-down (step 108). Otherwise, execute the initialization of the operation system of the computer (step 106), and proceed with the reading and compiling of the data stored in the computer.

In order to ensure and enhance the difficulty in breaking the power-on password, in the embodiment of the invention, upon receiving the computer power-down instruction, the new power-on password is stored to a specific storage area of the computer to replace the original power-on password, and it is also stored to a specific storage area of the outside data storage device as the new check-up password (step 107). As such, the new power-on password and new check-up password may be used in the power-on process of the computer system when the outside data storage area is used for activating the computer system next time. Through the change of the power-on password, the data security of the computer system can be significantly enhanced and thus preventing the illegal access and usage of the data by the ill-intended person. Consequently, following step 107, the computer executes the power-down operation (step 108).

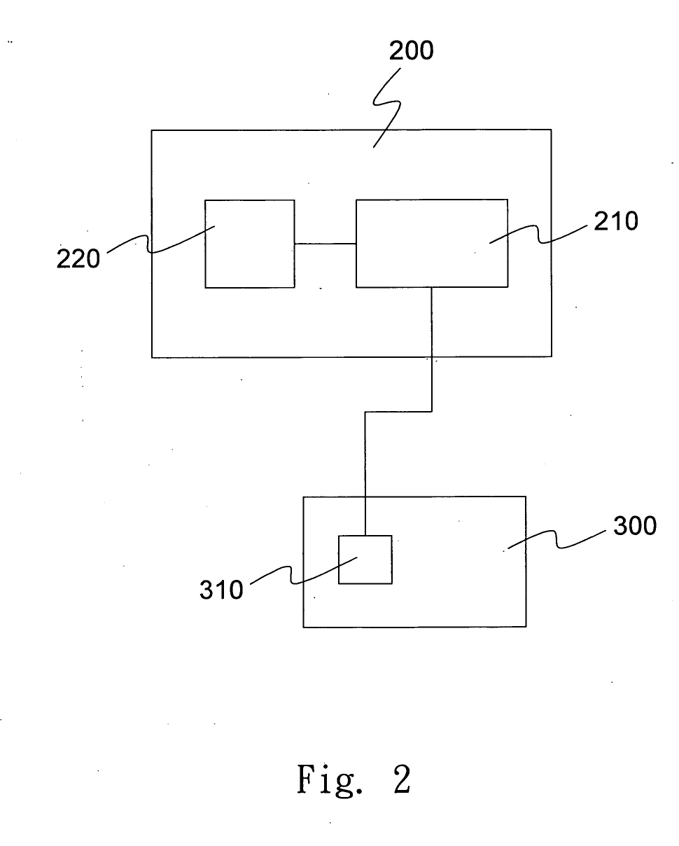

Next, refer to FIG. 2 for a schematic diagram of the computer data security system according to an embodiment of the invention, including an outside data storage device 300 and a computer 200. Wherein, a check-up password is stored in a specific address 310 of an outside data storage device 300, which can be connected to or separated from the computer 200. The computer 200 includes an operation system (not shown), a verification module 210, and a specific storage area 220, and the power-on password is stored in the specific storage area 220. In practical application, upon receiving the power-on signal, the computer 200 first verifies that the outside data storage device 300 is connected to it, and instructs the verification module 210 to verify that the power-on password is indeed compatible with the check-up password, and then proceeds with the initialization of the operation system.

In practice, the embodiment of the invention may be realized in a firmware or a software. In the former case, the verification module can be included in a BIOS (basic input/output system) or ASIC (application specific integrated circuit), thus in executing the BIOS, it can be verified that whether the power-on password is compatible with the check-up password. In addition, the specific storage area for storing the power-on password may be located in BIOS, and it can be made of ROM (read only memory), flash memory, erasable programmable ROM (EPROM) or Electrically Erasable Programmable ROM (EEPROM).

In case that the embodiment of the invention is realized in a software, then the verification module may be included in the kernel of the operation system, and it is loaded into the kernel of the operation system upon receiving the power-on. signal, hereby verifying that if the power-on password is compatible with the check-up password. The specific storage area of the computer may be located in a hard disk.

In addition, the outside data storage device according to the embodiment of the invention may be connected to or separated from the computer system through a connection port. Wherein, the connection port can be a Universal Serial Bus (USB), and the outside data storage device can be a USB storage device. Moreover, an Encoder IC may be provided in the invention, which is utilized to proceed with the encoding of the specific file data upon the activation of the computer.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer data security method, used to activate a computer in cooperation with an outside data storage device, said computer installed an operation system and stored with a power-on password, said outside data storage device stored with a check-up password, wherein said method comprising the following steps:
receiving a power-on signal;
verifying that said outside data storage device is connected to said computer;
obtaining said check-up password from said outside data storage device;
checking the power-on password is compatible with the check-up password; and
initializing said operation system to activate said computer.

2. The computer data security method of claim 1, further comprising the step of powering-down said computer, if said power-on password is not compatible with said check-up password.

3. The computer data security method of claim 1, further comprising the following steps after activating said computer:
receiving a power-down instruction;
storing a new power-on password to a specific storage area to replace said power-on password; and
storing said new power-on password to another specific storage area as said check-up password.

4. A computer data security system, comprising:
an outside data storage device, storing a check-up password; and
a computer, connected to or separated from said outside data storage device, and is composed of an operation system, a verification module, and a specific data storage area, said specific data storage area is stored with a power-on password, upon receiving a power-on signal, said verification module is used by said computer to verify if said power-on password is compatible with said check-up password, said operation system is initialized to activate said computer when said power-on password is compatible with said check-up password.

5. The computer data security system of claim 4, wherein said outside data storage device is connected to or separated from said computer system through a connection port.

6. The computer data security system of claim 5, wherein said connection port is a Universal Serial Bus (USB), and said outside data storage device is a USB data storage device.

7. The computer data security system of claim 4, further comprising a basic input/output system (BIOS) memory, said verification module is included in said BIOS memory.

8. The computer data security system of claim 7, wherein said specific storage area is located in said BIOS memory.

9. The computer data security system of claim 7, wherein said BIOS memory is selected from the group consisting of a flash memory, an erasable programmable ROM (EPROM) and an Electrically Erasable Programmable ROM (EEPROM).

10. The computer data security system of claim 4, further comprising: an application specific integrated circuit (ASIC), and said verification module is located in said application specific integrated circuit.

11. The computer data security system of claim 4, wherein said verification module is included in the kernel of said operation system.

12. The computer data security system of claim 4, wherein said computer further comprising a hard disk, and said specific storage area is located in said hard disk.

13. A computer, connected to an outside data storage device, and includes a check-up password, said computer comprising:
an operation system;
a specific data storage area, storing a power-on password; and
a verification module, used by said computer to check if said power-on password is compatible with said check-up password upon receiving a power-on signal, said operation system is initialized to activate said computer when the power-on password is compatible with the check-up password.

14. The computer of claim 13, wherein said outside data storage device is connected to or separated from said computer system through a connection port.

15. The computer of claim 14, wherein said connection port is a Universal Serial Bus (USB), and said outside data storage device is a USB data storage device.

16. The computer of claim 13, further comprising a basic input/output system (BIOS) memory, said verification module is included in said BIOS memory.

17. The computer of claim 16, wherein said specific storage area is located in said BIOS memory.

18. The computer of claim 16, wherein said BIOS memory is selected from the group consisting of a flash memory, an Erasable Programmable ROM (EPROM) and an Electrically Erasable Programmable ROM (EEPROM).

19. The computer of claim 13, further comprising an application specific integrated circuit (ASIC), and said verification module is located in said application specific integrated circuit.

20. The computer of claim 13, wherein said verification module is included in the kernel of said operation system.

21. The computer of claim 13, further comprising a hard disk, and said specific storage area is located in said hard disk.
